(19) United States
(12) Patent Application Publication
(10) Pub. No.: US 2024/0281856 A1
(43) Pub. Date: Aug. 22, 2024

(54) SYSTEMS AND METHODS FOR EFFICIENT MONTE CARLO OPTION PRICING AND DERIVATIVE PRICING MODEL CALIBRATION USING DEEP LEARNING AND GRAPHICS PROCESSING UNITS

(71) Applicant: JPMORGAN CHASE BANK, N.A., New York, NY (US)

(72) Inventors: Dushyant SAHOO, Foster City, CA (US); Leonard EUN, Lafayette, CA (US); Amit VARSHNEY, Fremont, CA (US); Manoj CHERUKUMALLI, San Jose, CA (US)

(21) Appl. No.: 18/583,029

(22) Filed: Feb. 21, 2024

Related U.S. Application Data
(60) Provisional application No. 63/486,176, filed on Feb. 21, 2023.

(51) Int. Cl. G06Q 30/0283

(52) U.S. Cl. CPC G06Q 30/0283

(57) ABSTRACT

A method may include: generating, by a computer program, random values for a plurality of pricing model parameters for a pricing model; receiving, by the computer program, a selection of a plurality of anchors; calculating, by the computer program, simulated prices for the plurality of anchors using the pricing model; training, by the computer program, encoder parameters for an encoder with the simulated prices to predict updated values for the pricing model parameters; predicting, by the pricing model using the updated values for the pricing model parameters, predicted prices for the anchors; computing, by the computer program using an error module, a loss between the simulated prices and the predicted prices; updating, by the computer program, the encoder parameters based on the loss; and deploying, by the computer program, the pricing model to a production environment in response to the loss being within a threshold range.

### RELATED APPLICATIONS

This application claims priority to, and the benefit of, U.S. Provisional Patent Application Ser. No. 63/486,176, filed Feb. 21, 2023, the disclosure of which is hereby incorporated, by reference, in its entirety.

### BACKGROUND OF THE INVENTION

### 1. Field of the Invention

Embodiments are generally directed to systems and methods for efficient Monte Carlo option pricing and derivative pricing model calibration using deep learning and graphics processing units.

### 2. Description of the Related Art

Financial derivatives pricing and hedging require high precision and substantial computational power. They are typically modeled using stochastic differential equations, which often rely on Monte Carlo simulations because the exact analytic solution is not always available. Despite the method's versatility, one apparent downside to Monte Carlo pricing is that it is generally much slower than the alternative analytic or numerical methods. In addition, Monte Carlo methods can become computationally very expensive when the parameter space is large and the precision requirement is high, as is often the case in financial applications. Thus, making Monte Carlo methods cost-effective and fast has been a long-standing challenge in quantitative finance.

### SUMMARY OF THE INVENTION

Systems and methods for efficient Monte Carlo option pricing and derivative pricing model calibration using deep learning and graphics processing units are disclosed. According to an embodiment, a method may include: (1) generating, by a computer program, random values for a plurality of pricing model parameters for a pricing model; (2) receiving, by the computer program, a selection of a plurality of anchors; (3) calculating, by the computer program, simulated prices for the plurality of anchors using the pricing model; (4) training, by the computer program, encoder parameters for an encoder with the simulated prices to predict updated values for the pricing model parameters; (5) predicting, by the pricing model using the updated values for the pricing model parameters, predicted prices for the anchors; (6) computing, by the computer program using an error module, a loss between the simulated prices and the predicted prices; (7) updating, by the computer program, the encoder parameters based on the loss; and (8) deploying, by the computer program, the pricing model to a production environment in response to the loss being within a threshold range.

In one embodiment, a type of the pricing model parameters may be based on a type of the pricing model.

In one embodiment, a type of the pricing model may be selected by a user.

In one embodiment, the pricing model may include a Heath-Jarrow-Morton model.

In one embodiment, the simulated prices may be generated using a Monte Carlo model.

In one embodiment, the encoder parameters may be initialized to random values.

In one embodiment, the plurality of anchors comprise securities that are liquid.

In one embodiment, the loss may be calculated using a mean square error.

In one embodiment, the encoder parameters may be modified using machine learning techniques.

In one embodiment, the encoder parameters may be modified using a gradient descent algorithm.

According to another embodiment, a non-transitory computer readable storage medium may include instructions stored thereon, which when read and executed by one or more computer processors, cause the one or more computer processors to perform steps comprising: generating random values for a plurality of pricing model parameters for a pricing model; receiving a selection of a plurality of anchors; calculating simulated prices for the plurality of anchors using the pricing model; training encoder parameters for an encoder with the simulated prices to predict updated values for the pricing model parameters; predicting, using the updated values for the pricing model parameters, predicted prices for the anchors; computing a loss between the simulated prices and the predicted prices; updating the encoder parameters based on the loss; and deploying the pricing model to a production environment in response to the loss being within a threshold range.

In one embodiment, a type of the pricing model parameters may be based on a type of the pricing model.

In one embodiment, a type of the pricing model may be selected by a user.

In one embodiment, the pricing model may include a Heath-Jarrow-Morton model.

In one embodiment, the simulated prices may be generated using a Monte Carlo model.

In one embodiment, the encoder parameters may be initialized to random values.

In one embodiment, the plurality of anchors comprise securities that are liquid.

In one embodiment, the loss may be calculated using a mean square error.

In one embodiment, the encoder parameters may be modified using machine learning techniques.

In one embodiment, the encoder parameters may be modified using a gradient descent algorithm.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 depicts a system for efficient Monte Carlo option pricing and derivative pricing model calibration using deep learning and graphics processing units according to an embodiment;

FIG. 2 depicts a method for efficient Monte Carlo option pricing and derivative pricing model calibration using deep learning and graphics processing units according to an embodiment; and

FIG. 3 depicts an exemplary computing system for implementing aspects of the present disclosure.

### DETAILED DESCRIPTION OF PREFERRED EMBODIMENTS

Systems and methods for efficient Monte Carlo option pricing and derivative pricing model calibration using deep learning and graphics processing units are disclosed.

It should be noted that the references to commercial products herein is exemplary only and embodiments are not limited to the commercial products identified.

Embodiments may use a combination of the machine learning-based importance sampling method to accelerate the convergence and the use of end-to-end machine learning platforms and graphical processing units (GPUs) to make the generation of simulation paths more efficient. For example, embodiments may employ variance reduction techniques. Fewer simulations are needed if the variance of the terminal distribution can be reduced without affecting the expected value. Variance reduction techniques become practical when the resulting reduction in number of paths outweighs the added computational costs. Thus, embodiments may use an end-to-end machine learning platform on a GPU along with variance reduction to reduce the number of paths. GPU acceleration may help by reducing computational cost of variance reduction; and by accelerating compute of paths.

Embodiments may use the Schoenmakers-Heemink (SH) algorithm to reduce the variance of Monte Carlo simulation. An approximate analytic pricer may be used. In this scheme, the drift of the underlying stochastic process may be continuously adjusted according to the approximate price, which results in variance reduction that is inversely proportional to the square of the error in the approximate price.

Let (Vₜ) be an n-dimensional stochastic process which evolves as follows:

$$\\ \begin{matrix}{dV}_{t} = b ( t , {V}_{t} ) dt + a ( t , {V}_{t} ) d {η}_{t} , & ( 1 )\end{matrix}$$

where ηₜ is a standard n-dimensional Brownian motion, b∈Rⁿ, a∈R^{n×n}, R is a real number, and a and b are functions that satisfy the usual regularity and boundedness assumptions to ensure existence and uniqueness of the solution.

Given a real function ϕ(v) with polynomial growth, a Monte Carlo simulation consists of approximating u(t,v), where u is the variable of interest, that changes depending on equation 4 or 5 below, as follows:

$$\\ \begin{matrix}u ( t , v ) \approx \frac{1}{N} {\sum }_{k = 1}^{N} ϕ ( {V}_{T}^{k} ) & ( 2 )\end{matrix}$$

where (V^{k}, k=1, . . . , N) are independent realizations of the process V, N is the number of Monte Carlo simulations, T is the maturity and V_{T}^{k} is the realization of process V in equation (1).

The SH algorithm adds an extra drift term by replacing the driving Weiner processes nₜ by −h+ηₜ, where h is:

$$\\ \begin{matrix}h = - \frac{1}{u} {a}^{{}_{} T} ∇ u & ( 3 )\end{matrix}$$

where h is a function using a and u as inputs.

This addition of h helps reduce the variance of the paths. If u(t,v) were known, then the problem would be solved and the optimal choice for h, mentioned above would result in zero variance. The main idea is to use an approximation for the unknown u in the previous formula which gives a function h such that the variance can be reduced.

Embodiments may use the advantages provided by deep learning to approximate an analytic pricer.

For example, embodiments may generate 50 million synthetic data points for the Heath Jarrow Morton (HJM) model and the Heston model using equations (4), (5) and (6) below, each estimated from 100 k Monte Carlo paths.

Embodiments may use this dataset for training neural network where the input features are model parameters and the output is h, described in equation (3), above.

Embodiments may use a neural network with, for example, five layers and each layer containing, for example, 128 nodes and root mean squared error as an error metric.

To demonstrate this approach, an example uses swaption pricing based on the HJM model, an industry standard model of interest rates, and barrier option pricing based on the Heston model, a stochastic volatility model.

In the HJM model, the instantaneous forward interest rate with maturity T is assumed to satisfy the stochastic differential equation:

$$\\ \begin{matrix}df ( t , T ) = α ( t , T ) dt + σ ( t , T ) dW ( t ) & ( 4 )\end{matrix}$$

where α and σ are adapted and W is a Brownian motion under a risk-neutral measure.

The basic Heston model assumes that spot SI, the price of the asset, is determined by a stochastic process:

$$\\ \begin{matrix}{dS}_{t} = μ {S}_{t} dt + \sqrt{{v}_{t}} {S}_{t} {dW}_{t}^{{}_{} S} & ( 5 )\end{matrix}$$

where vₜ, the instantaneous variance, is given by a Feller square root or CIR process:

$$\\ \begin{matrix}{dv}_{t} = κ ( Θ - {v}_{t} ) dt + ζ \sqrt{{v}_{t}} {dW}_{t}^{{}_{} v} & ( 6 )\end{matrix}$$

and Wₜ^{S}, Wₜ^{v} are Weiner processes with correlation ρ.

For simplicity, a European call option which is a contract that gives its holder the right, but not the obligation, to buy at maturity T one unit of the underlying asset for a predetermined strike price K is considered. The value of this call option at maturity, its payoff, is given by:

$$\\ ϕ ( {X}_{T} ) = {( {X}_{T} - K )}^{+} = \{ \begin{matrix}{X}_{T} - K , & if {X}_{T} > K \\ 0 , & otherwise\end{matrix}$$

Embodiments may measure improvement (or a decrease) in variance by the SH algorithm which is variance of original model divided by variance of the model with the SH algorithm. For example:

TABLE 1
Gains for Heston model.

| | | Strike | | |
|---|---|---|---|---|
| | | 0.3 | 0.4 | 0.5 |
| Spot | 0.3 | 9 | 17 | 25 |
| | 0.4 | 16 | 8 | 12 |
| | 0.5 | 22 | 13 | 8 |

TABLE 2
Gains for HJM model.

| | | Strike | | |
|---|---|---|---|---|
| | | 0.01 | 0.013 | 0.02 |
| Swap rate | 0.009 | 12 | 8 | 3 |
| | 0.013 | 30 | 27 | 9 |
| | 0.019 | 29 | 20 | 15 |

Table 1 shows improvement in variance for different value of Strike and Spot which are the option parameters (i.e., for a European option). Similarly, Table 2 shows improvement for different option parameters. This illustrates that while the performance of the algorithm is dependent on option parameters, there is always improvement.

Embodiments may use a high-level, general purpose programming language, such as Python, with the end-to-end machine learning platform for the implementation and all the computations may be performed on a GPU. Embodiments may reduce the running time of each simulation and the additional cost of machine-learning based pricing. Speedups in generating simulated paths using the GPUs may be achieved due to the parallel nature of Monte Carlo methods and the use of computationally intensive linear algebra routines.

In the example above, this speedup helps in simulating 50 million prices, each estimated from 100,000 Monte Carlo paths in less than a day on the GPU.

In addition, automatic differentiation allows for O(1) estimation of sensitivities. O(1) indicates that the runtime of an algorithm remains constant regardless of the size of the input. This provides predictable algorithms in situations where performance and responsiveness play a role.

With the approximate pricer for the Schoenmakers-Heemink algorithm, embodiments may achieve a reduction in variance for option prices. One clear advantage of this approach is that it can be used where an approximate analytic formula does not exist.

Another advantage, compared to the full ML based pricing, is its better generalizability. For example, in the event of a rapid market regime shift, ML based pricing will be biased by the training data, increasing error. Whereas in embodiments, the desired level of accuracy may be achieved by checking the convergence online and running more Monte Carlo samples accordingly.

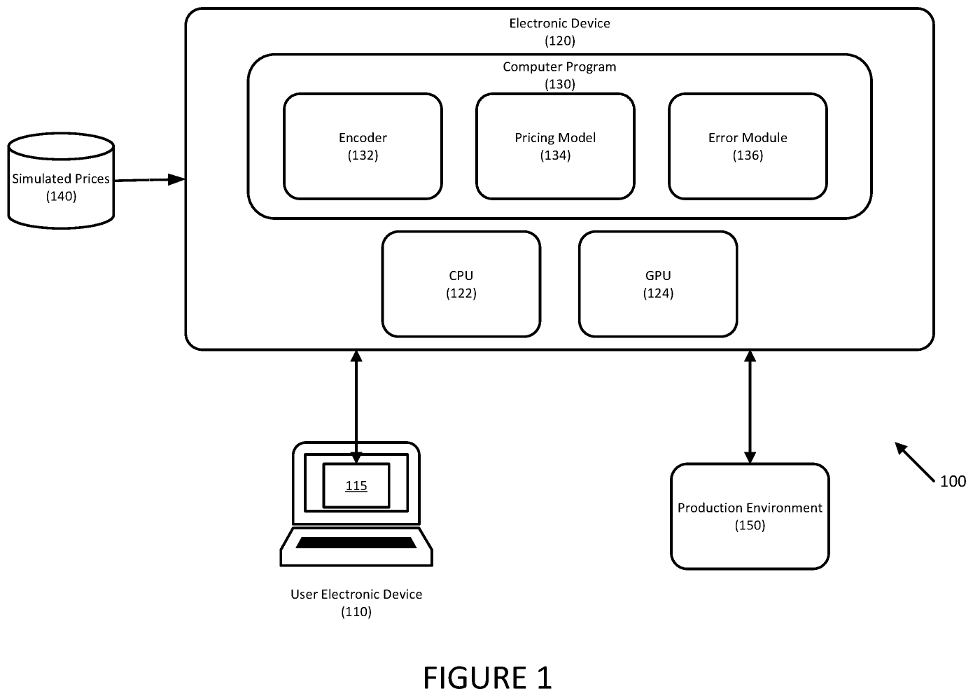

Referring to FIG. 1, a system for efficient Monte Carlo option pricing and derivative pricing model calibration using deep learning and graphics processing units is disclosed according to an embodiment. System 100 may include electronic device 120, which may be a server (e.g., cloud-based and/or physical), a computer (e.g., workstation, desktop, laptop, notebook, tablet, etc.), etc. Electronic device 120 may include central processing unit (CPU) 122 and graphical processing unit (GPU) 124. CPU 122 may handle certain tasks and GPU 124 may handle others. For example, GPU 124 may execute an end-to-end machine learning platform along with variance reduction. GPU 124 may provide acceleration relative to CPU 122.

Electronic device 120 may execute computer program 130. Computer program 130 may include a plurality of modules, such as encoder 132, pricing model 134, and error module 136. Encoder 132 may receive simulated prices from simulated price database 140 and may output model parameters for pricing model 134. Pricing model 134, which may be a machine learning model, may receive the model parameters and may output predicted prices to error module 136. In embodiments, encoder 132, pricing model 134, and error module 136 may be executed by GPU 124 and/or CPU 122.

In embodiments, pricing model 134 may be a Monte Carlo model, machine learning pricing model, etc. Error module 136 may also receive simulated prices from simulated price database 140 and may determine a difference between the two using, for example, the mean square error. The parameters are modified to minimize the difference, and then the process is repeated.

In one embodiment, the process may be repeated until the error is within a predetermined tolerance range. Once the error is within the predetermined tolerance range, which may be set by the user, the model training is complete. The model may then be used to calibrate pricing model parameters and deployed to production.

User electronic device 110 may access electronic device 120 using, for example, user computer program 115. For example, using user computer program 115, a user may provide parameters, such as anchor selection.

Once training is complete, pricing model 134 may be deployed to production environment 150.

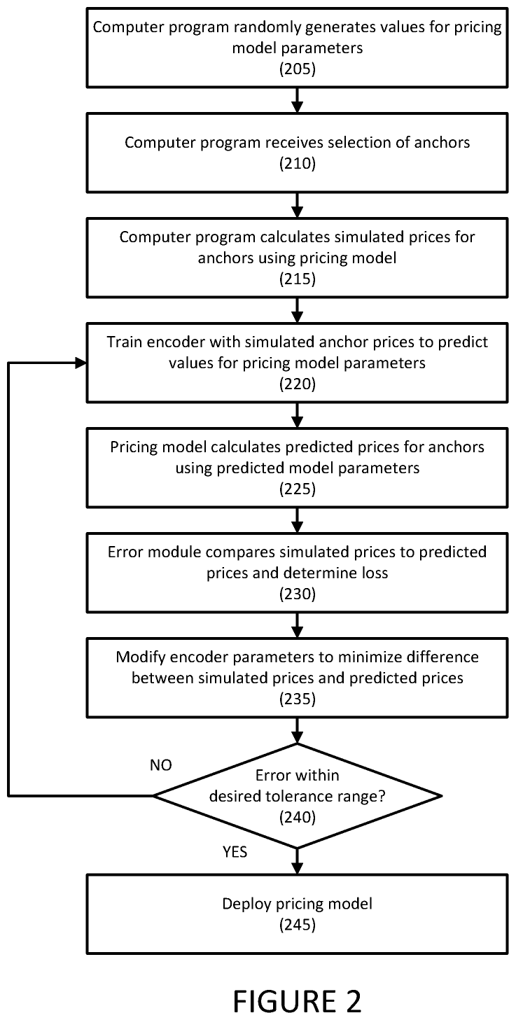

Referring to FIG. 2, a method for efficient Monte Carlo option pricing and derivative pricing model calibration using deep learning and graphics processing units is disclosed according to an embodiment.

In step 205, a computer program may randomly generate values for model parameters, such as pricing model parameters, that are used by a pricing model to calculate anchor prices, which, in turn, are used to train the pricing model.

In embodiments, the pricing model may be selected by the user. In general, different options are priced using different models. For example, interest rate options may be priced using the Heath-Jarrow-Morton (HJM) Model. To price different options, such as equity options, users might use a different pricing model.

In step 210, the computer program may receive a selection of anchors, such as anchor securities. Any security may be selected as the anchor security. For example, the most liquid options may be selected as the anchor securities to calibrate the pricing model.

In one embodiment, the selection of anchors may be received from the user.

In step 215, using the pricing model, the computer program may calculate simulated prices for the anchors using the pricing model.

In step 220, the computer program may train an encoder to predict values for the pricing model parameters using the simulated prices for the anchors.

In one embodiment, the encoder may be trained by starting with random encoder model parameters that should give inaccurate predictions for the values for the pricing model parameters. The encoder may then be trained with the simulated prices for the anchors to provide more accurate predictions for the values for the pricing model parameters. In embodiments, the training of the encoder may continue until the values for the pricing model parameters converge.

The computer program may then provide the predicted values for the pricing model parameters to the pricing model.

In step 225, using the predicted values for the pricing model parameters, the pricing model may then calculate predicted prices for the anchors.

In step 230, the error module may compare the predicted prices for the anchors to the simulated prices to determine the error between the two. In one embodiment, the error module may use the mean square error to calculate the loss.

In step 235, the encoder parameters may be modified to minimize the loss, or difference, between the simulated prices and the predicted prices. In embodiments, mathematical techniques that are typically used in machine learning training libraries may be used to modify the encoder parameters based on the loss.

In one embodiment, a gradient descent algorithm may be used to modify the encoder parameters in the direction of the gradient of the loss function with respect to the encoder parameters.

The modified pricing model parameters may be provided to the encoder, which may then predict updated pricing model parameters for the pricing model. The updated pricing model parameters may then be used by the pricing model to predict prices for the anchors.

The process may continue until the loss between the simulated prices and the predicted prices is within a desired tolerance range, which may be set by the user. If, in step 240, the error is not within the desired tolerance range, the process may continue to step 220. If the error is within the desired tolerance range, in step 245, the pricing model may be deployed to, for example, a production environment.

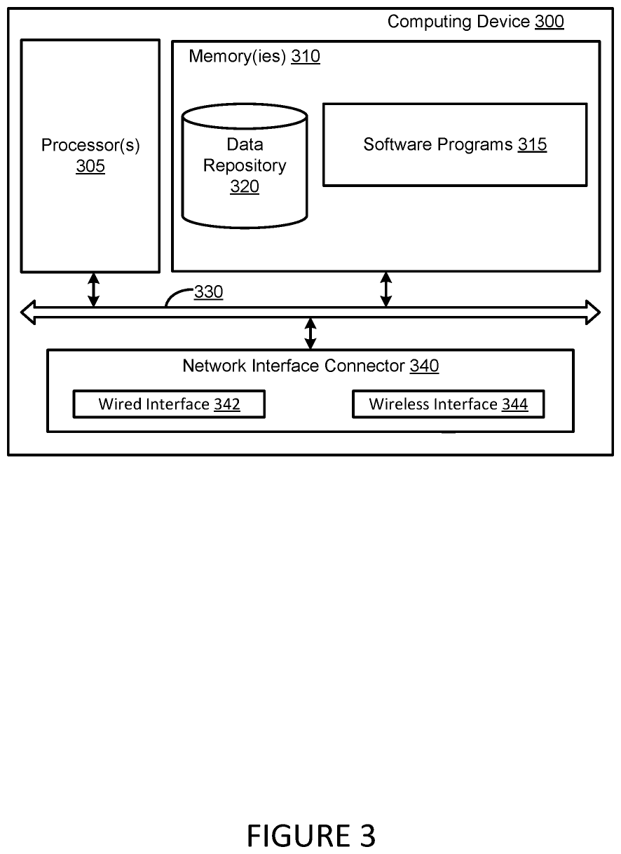

FIG. 3 depicts an exemplary computing system for implementing aspects of the present disclosure. FIG. 3 depicts exemplary computing device 300. Computing device 300 may represent the system components described herein. Computing device 300 may include processor 305 that may be coupled to memory 310. Memory 310 may include volatile memory. Processor 305 may execute computer-executable program code stored in memory 310, such as software programs 315. Software programs 315 may include one or more of the logical steps disclosed herein as a programmatic instruction, which may be executed by processor 305. Memory 310 may also include data repository 320, which may be nonvolatile memory for data persistence. Processor 305 and memory 310 may be coupled by bus 330. Bus 330 may also be coupled to one or more network interface connectors 340, such as wired network interface 342 or wireless network interface 344. Computing device 300 may also have user interface components, such as a screen for displaying graphical user interfaces and receiving input from the user, a mouse, a keyboard and/or other input/output components (not shown).

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method, comprising:
generating, by a computer program, random values for a plurality of pricing model parameters for a pricing model;
receiving, by the computer program, a selection of a plurality of anchors;
calculating, by the computer program, simulated prices for the plurality of anchors using the pricing model;
training, by the computer program, encoder parameters for an encoder with the simulated prices to predict updated values for the pricing model parameters;
predicting, by the pricing model using the updated values for the pricing model parameters, predicted prices for the anchors;
computing, by the computer program using an error module, a loss between the simulated prices and the predicted prices;
updating, by the computer program, the encoder parameters based on the loss; and
deploying, by the computer program, the pricing model to a production environment in response to the loss being within a threshold range.

2. The method of claim 1, wherein a type of the pricing model parameters is based on a type of the pricing model.

3. The method of claim 2, wherein a type of the pricing model is selected by a user.

4. The method of claim 1, wherein the pricing model comprises a Heath-Jarrow-Morton model.

5. The method of claim 1, wherein the simulated prices are generated using a Monte Carlo model.

6. The method of claim 1, wherein the encoder parameters are initialized to random values.

7. The method of claim 1, wherein the plurality of anchors comprise securities that are liquid.

8. The method of claim 1, wherein the loss is calculated using a mean square error.

9. The method of claim 1, wherein the encoder parameters are modified using machine learning techniques.

10. The method of claim 9, wherein the encoder parameters are modified using a gradient descent algorithm.

11. A non-transitory computer readable storage medium, including instructions stored thereon, which when read and executed by one or more computer processors, cause the one or more computer processors to perform steps comprising:
generating random values for a plurality of pricing model parameters for a pricing model;
receiving a selection of a plurality of anchors;
calculating simulated prices for the plurality of anchors using the pricing model;
training encoder parameters for an encoder with the simulated prices to predict updated values for the pricing model parameters;
predicting, using the updated values for the pricing model parameters, predicted prices for the anchors;
computing a loss between the simulated prices and the predicted prices;
updating the encoder parameters based on the loss; and
deploying the pricing model to a production environment in response to the loss being within a threshold range.

12. The non-transitory computer readable storage medium of claim 11, wherein a type of the pricing model parameters is based on a type of the pricing model.

13. The non-transitory computer readable storage medium of claim 12, wherein a type of the pricing model is selected by a user.

14. The non-transitory computer readable storage medium of claim 11, wherein the pricing model comprises a Heath-Jarrow-Morton model.

15. The non-transitory computer readable storage medium of claim 11, wherein the simulated prices are generated using a Monte Carlo model.

16. The non-transitory computer readable storage medium of claim 11, wherein the encoder parameters are initialized to random values.

17. The non-transitory computer readable storage medium of claim 11, wherein the plurality of anchors comprise securities that are liquid.

18. The non-transitory computer readable storage medium of claim 11, wherein the loss is calculated using a mean square error.

19. The non-transitory computer readable storage medium of claim 11, wherein the encoder parameters are modified using machine learning techniques.

20. The non-transitory computer readable storage medium of claim 19, wherein the encoder parameters are modified using a gradient descent algorithm.
